(19) United States
(12) Patent Application Publication
(10) Pub. No.: US 2024/0125513 A1
(43) Pub. Date: Apr. 18, 2024

(54) ELECTRIC AIR HEATER

(71) Applicant: Lummus Technology LLC, Houston, TX (US)

(72) Inventors: Baozhong Zhao, Houston, TX (US); Richard Jibb, Houston, TX (US); David Guymon, Houston, TX (US); Alejandro Carrillo, Houston, TX (US)

(73) Assignee: Lummus Technology LLC, Houston, TX (US)

(21) Appl. No.: 18/486,607

(22) Filed: Oct. 13, 2023

Related U.S. Application Data
(60) Provisional application No. 63/379,577, filed on Oct. 14, 2022.

(51) Int. Cl. F24H 3/04; H05B 1/02

(52) U.S. Cl. CPC F24H 3/0405; H05B 1/0244; H05B 2203/005

(57) ABSTRACT

An electric air heater system including a first electric air heater module. The first electric air heater module including an outer casing having an inner surface, a first end, and a second end; a refractory insulation layer in tight communication with the outer casing; an inner cavity within the refractory insulation layer; and a plurality of tubes extending through the inner cavity from the first end to the second end, the plurality of tubes each having an exterior surface. Each tube is fixed relative to the outer casing at the first end, and each tube has an electrical connection disposed at the first end. The plurality of tubes is arranged into one or more bundles of tubes, where each bundle includes two or more tubes having a plurality of fins extending radially from the exterior surface, and a heating element axially through a hollow interior of the tube.

### FIELD OF THE DISCLOSURE

Embodiments of the present disclosure generally relate to large capacity electric air heater systems capable of heating gases, or other fluids, to temperatures in excess of 343° C.

### BACKGROUND

Electrical heating of gases can be carried out using an intermediate heat transfer fluid, such as hot oil or molten salt. However, such systems have a maximum operating temperature of 400° C. Electrical heating of gases at higher temperatures is typically achieved via one of two types of electrical heater systems.

First, electrical heating may be achieved by using a gas heater assembly, which relies on convective heating of gases. Gas heater assemblies are widely available commercially, however current designs are limited in their ability to heat large volumes of air in a single enclosure to a high temperature with a low pressure drop. Further, currently available gas heater modules are also characterized by small channel sizes, direct contact between heating elements and process gases, and low watt densities due to the high temperature of the heating element which is required to dissipate heat. This, in turn, causes overheating and premature failure of heating elements.

Alternatively, furnace tube assemblies are also currently available commercially. A furnace tube assembly is a modular assembly, which is characterized by discrete heating device sections installed into a casing. Furnace tube assemblies transfer heat radiatively between heating elements and furnace tubes and then from the furnace tubes to the workpiece. Attempts to increase surface area by adding an extended surface offers only modest improvements due to the lower view factor which exists between the extended surface and the radiatively heated workpiece.

Current solutions are typically characterized by a number of undesirable factors. First, process gases are often exposed directly to heating elements. This may limit the number of different process gases that can be heated within the heater assemblies. In particular, process gases which are corrosive, flammable, or otherwise difficult to work with would be excluded from use with such heater assemblies. In addition, direct flow of gases over heating elements can cause heating elements to vibrate or otherwise move. This can lead to short circuiting or breakage at connection points. Further, current solutions also involve flowing process gases directly through tubes within a larger, conventional heater assembly.

Currently available electric heaters are also limited in that they include flow channels with relatively small cross-sections and high flow resistance. This reduces the suitability of the heater for heating large volumes of gas, while maintaining a low pressure drop.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one or more aspects, embodiments disclosed herein relate to an electric air heater system including a first electric air heater module. The first electric air heater module including an outer casing having an inner surface, a first end, and a second end; a refractory insulation layer in tight communication with the outer casing; an inner cavity within the refractory insulation layer; and a plurality of tubes extending through the inner cavity from the first end to the second end, the plurality of tubes each having an exterior surface. Each tube is fixed relative to the outer casing at the first end, and each tube has an electrical connection disposed at the first end. The plurality of tubes is arranged into one or more bundles of tubes, where each bundle includes two or more tubes having a plurality of fins extending radially from the exterior surface, and a heating element axially through a hollow interior of the tube, and a sleeve supporting each of the plurality of tubes at the second end of the outer casing.

In other aspect, embodiments disclosed herein relate to an electric air heater. The electric air heater including an outer casing, having an inner surface defining an inner cavity, a first end, and a second end; a refractory insulation layer in tight communication with the outer casing; and a plurality of tubes extending axially through the inner cavity from the first end to the second end, the plurality of tubes each having an exterior surface. The plurality of tubes is arranged radially around an axial center of the inner cavity. Each tube is fixed relative to the outer casing at the first end, and each tube has an electrical connection disposed at the first end. Each tube has a plurality of fins arranged extending radially from the exterior surface, an electrical heating element disposed axially through a hollow interior of the tube, and a sleeve supporting each of the plurality of tubes at the second end of the outer casing.

In yet another aspect, embodiments disclosed herein relate to a method of heating air. The method including directing a volume of air into an electric air heater having an inner cavity, directing the volume of air through the inner cavity, and heating the volume of air.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying FIGURES. Like elements in the various FIGURES are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing. Additionally, a single reference numeral may be used to denote a flow line and the process stream within the flow line.

FIGS. 1A and 1B shows an electric air heater module in accordance with one or more embodiments.

FIGS. 2A and 2B show an electric air heater module in accordance with one or more embodiments.

FIG. 3 shows a cross-sectional view of a tube within an electric air heater module in accordance with one or more embodiments.

FIG. 4 shows a cross-sectional view of a tube within an electric air heater module in accordance with one or more embodiments.

FIG. 5 shows a cross-sectional view of a tube within an electric air heater module in accordance with one or more embodiments.

FIG. 6 shows a cross-sectional view of a tube within an electric air heater module in accordance with one or more embodiments.

FIG. 7 shows a cutaway view of an electric air heater module in accordance with one or more embodiments.

FIG. 8 shows a cutaway view of an electric air heater module in accordance with one or more embodiments.

FIG. 9 shows a cross-sectional view of an electric air heater module in accordance with one or more embodiments.

FIG. 10 shows a cross-sectional view of an electric air heater module in accordance with one or more embodiments.

FIG. 11 shows a cross-sectional view of an electric air heater module in accordance with one or more embodiments.

FIG. 12 shows a flowchart of a method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

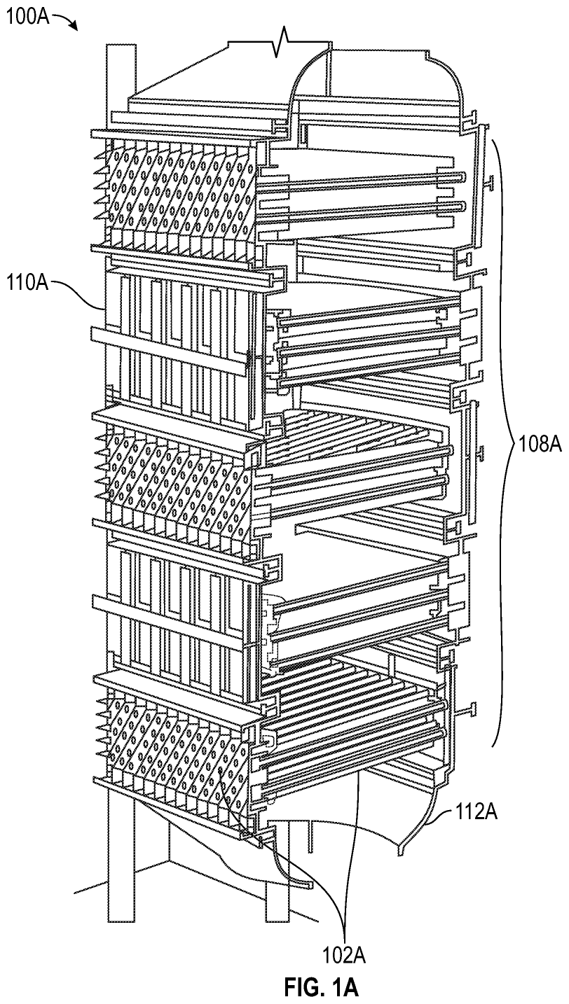

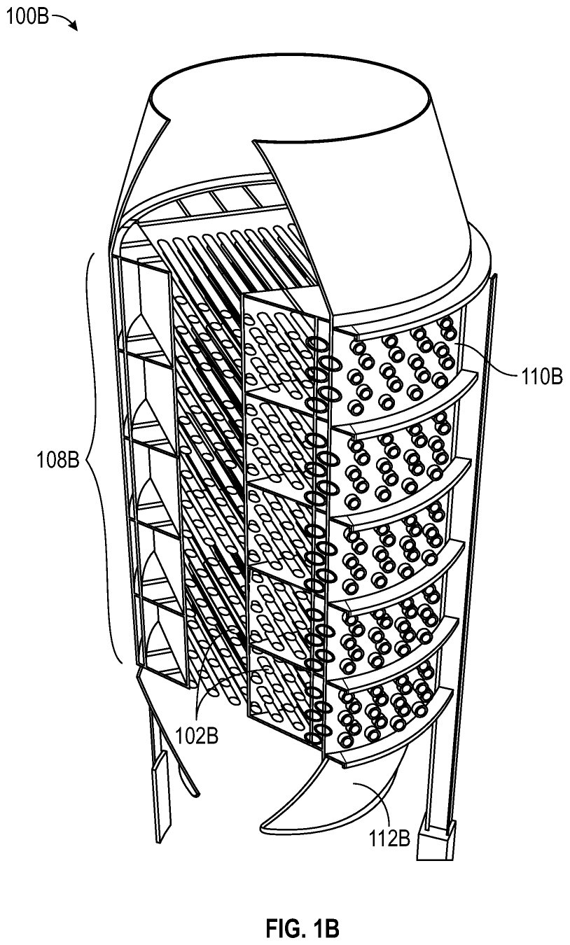

In the following description of FIGS. 1-12, any component described with regard to a FIGURE, in various embodiments disclosed herein, may be equivalent to one or more like-named components described with regard to any other FIGURE. For brevity, descriptions of these components will not be repeated with regard to each FIGURE. Thus, each and every embodiment of the components of each FIGURE is incorporated by reference and assumed to be optionally present within every other FIGURE having one or more like-named components. Additionally, in accordance with various embodiments disclosed herein, any description of the components of a FIGURE is to be interpreted as an optional embodiment which may be implemented in addition to, in conjunction with, or in place of the embodiments described with regard to a corresponding like-named component in any other FIGURE.

It is to be understood that the singular forms “a,” “an,” and “the” include plural referents unless the context clearly dictates otherwise. Thus, for example, reference to “an electric heater module” includes reference to one or more of such electric heater modules.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Disclosed herein are embodiments of an electric air heater system which may sustain high temperatures, particularly those in excess of 343° C. In one or more embodiments, the electric air heater system may heat large volumes of air, or any other fluid, to temperatures of up to 760° C. In some embodiments, air, steam, or other fluids may be heated to a temperature of up to 900° C., 950° C., 1000° C., 1050° C., 1100° C. or even up to 1400° C. Further, disclosed herein are embodiments of an electric air heater system that combines radiative heat transfer from heating elements to tubes, and convective heat transfer from tubes to a process gas flowing through the electric air heater system.

In addition, disclosed herein are embodiments of an electric air heater system using two or more banks of tubes. Each bank of tubes may have a varying power duty, where the total power of the electric air heater system is significantly higher than commercially available systems. In contrast, currently available systems require multiple heaters to be connected in series or parallel to achieve the same total power.

FIGS. 1A and 1B depict an electric air heater module 100A, 100B in accordance with one or more embodiments. The electric air heater module 100A, 100B may have a central portion 110A, 110B which is rectangular or square in shape (110A). However, there are many other geometries for central portion, such as cylindrical (110B), that are also possible. The electric air heater module 100A, 100B may also have two tapered ends 112A, 112B extending from opposite sides of the central portion 110A, 110B.

The central portion 110A, 110B may house the internal components of the electric air heater module. For example, a plurality of rows 108A, 108B of tubes 102A, 102B may be arranged such that the tubes 102A, 102B extend through the central portion 110. In one or more embodiments, there may be 25 rows 108A, 108B of tubes 102A, 102B arranged within the central portion 110A, 110B and more than 5 tubes 102A, 102B in the same row. However, in other embodiments there may be between 5 and 50 rows 108A, 108B arranged within the central portion 110A, 110B. The number of rows used may depend upon the desired temperature rise (heating) of the fluid passing over and around the tubes, and in some embodiments greater than 50 rows may be used, such as 60, 70, 80, 90, 100 or more rows.

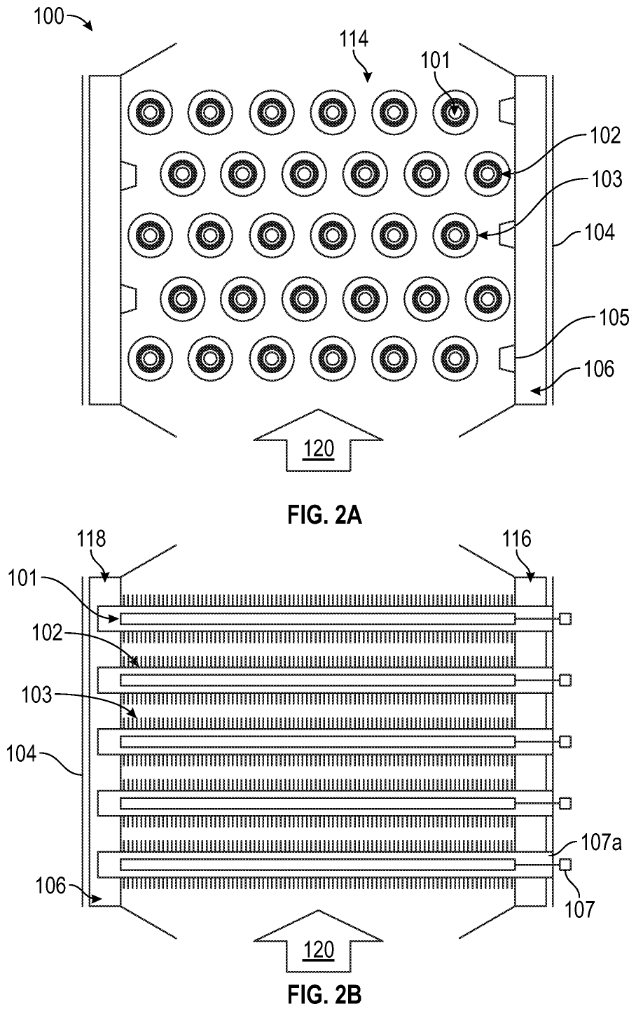

Turning now to FIGS. 2A and 2B, FIG. 2A shows a cross-sectional view of an electric air heater module and FIG. 2B shows a side view of an electric air heater module 100 in accordance with one or more embodiments. The electric air heater module 100 may have an outer casing 104 and a refractory insulation layer 106 in tight communication with the interior of the outer casing 104. In one or more embodiments, tight communication may mean that the refractory insulation layer 106 and the outer casing 104 may have a negligible spacing between the insulation layer 106 and the outer casing 104. A plurality of corbels 105 may be arranged around the inner surface of the refractory insulation layer 106. An inner cavity 114 may extend through the outer casing 104, such that the module is hollow.

In one or more embodiments, a gas, such as air 120 or another process gas, may be directed through the inner cavity 114, where the gas may be heated. In one or more embodiments, the electric air heater module 100 may have geometry that is rectangular, square, cylindrical, or any combination thereof. In embodiments where particularly high pressures are present, the electric air heater module 100 may have more than one outer casing 104 layer, which may cascade the operating pressure and minimizing casing deflection. Further, embodiments with more than one outer casing 104 layer may add an extra safety factor for heater operation and may maintain thermal insulation integrity.

A plurality of tubes 102 may be arranged in several rows throughout the inner cavity 114. The tubes may be of a similar or different outer diameter and may be disposed within the inner housing of the heater module using a uniform or a non-uniform spacing. In one or more embodiments, the tubes 102 may be made from an alloy suited for high furnace temperatures. However, since the gas flow through the electric air heater module 100 may cool the tubes 102, the alloy may be selected for a lower design temperature than would be needed if the tube 102 itself were the resistance heating element. For example, in one or more embodiments, the tubes 102 may be made from 304 stainless steel or an INCONEL alloy. For modules having a curved geometry, such as a cylindrical inner housing, the effective length of the tubes disposed within the inner housing may vary, such as where a length of the tube traversing proximate the center of the cylindrical housing are longer than tubes traversing proximate a side of the cylindrical housing.

Each tube 102 may have a plurality of fins 103 arranged circumferentially on a tube exterior surface. In one or more embodiments, the plurality of fins 103 extends radially from the exterior surface of each tube 102. Alternatively, there may be embodiments in which the plurality of fins 103 are arranged in a tight helical pattern around the exterior surface of each tube 102. The plurality of fins 103 may increase the surface area for convective heat transfer between each tube 102 and the gas directed into the electric air heater module 100 for heating. In one or more embodiments, the fins 103 may be circular fins. However, in other embodiments the fins 103 may be solid fins, serrated fins, or stud fins. In one or more embodiments, the fins may have an outer diameter, a fin frequency, a fin height and a fin thickness, all of which may be selected to fit situational heating needs and promote turbulent flow within the heater. The fin height, fin thickness, number of fins per unit length, and other fin variables may vary between the tubes. For example, fins provided on tubes proximate an inlet of the heater module may be different than fins proximate an outlet of the heater module. In some embodiments, for example, the fins may be made from an 18-chromium-8-nickel alloy or a 11-13 chromium alloy. However, it should be understood that these are only examples, and there are many other alloys which may also be used without departing from the scope of this disclosure.

Each tube 102 may also have a heating element 101 extending axially through the interior of the tube 102. There may be many different types of heating elements 101 which may be utilized within the tubes 102. In one or more embodiments, the heating elements 101 may be iron-chromium-aluminum metallic wires or nickel-chromium metallic wires. However, in other embodiments the heating elements 101 may be silicon carbide rod-type heating elements or molybdenum disilicide heating elements. In one or more embodiments, the heating elements 101 may be bent into a U-shape or a hairpin shape such that an electrical circuit is formed between the two ends of the element. Further, individual heating elements 101 may be grouped into bundles, which may be supported by ceramic spacers installed along the length of the tubes 102. The individual heating elements 101 may be grouped together in a parallel configuration, a series configuration, or both configurations simultaneously depending on the element types and situational needs.

In one or more embodiments, the heating elements 101 may radiatively heat the tubes 102. The tubes 102 may convectively dissipate heat as the cooler, process gas passes over the tubes 102, lowering the temperature of the tubes 102. Heat dissipation may also be enhanced by the installation of fins 103, which increase the effective surface area for convective heat transfer. Further, convective heat transfer may reduce the temperature of both the tube 102 and the heating element 101, allowing for the heating elements 101 to maintain a higher watt density than would otherwise be possible.

Turning now to FIG. 2B, the inner cavity 114 may extend from a first end 116 of the electric air heater module 100 to a second end 118. Each tube 102 may be fixed at the first end 116, where the fixed connection also serves as an electrical connection point. In one or more embodiments, a cable 107a may extend from each heating element 101 to an electrical connection 107 disposed on an exterior surface of the outer casing 104. Each tube 102 may be floating at the second end 118, allowing for expansion during heating. In one or more embodiments, each tube 102 may have a corresponding support located at the second end 118. In one or more embodiments, one or more cable 107a and connection 107 may be placed on the end of 118 opposite to the other cable 107a and connection 107 such that the cable and connection are distributed on both ends.

In one or more embodiments, a variety of sensors and connections may be installed within the electric air heater module 100. For example, in some embodiments, thermocouples and/or pressure sensors/connections may be installed as needed within the electric air heater modules.

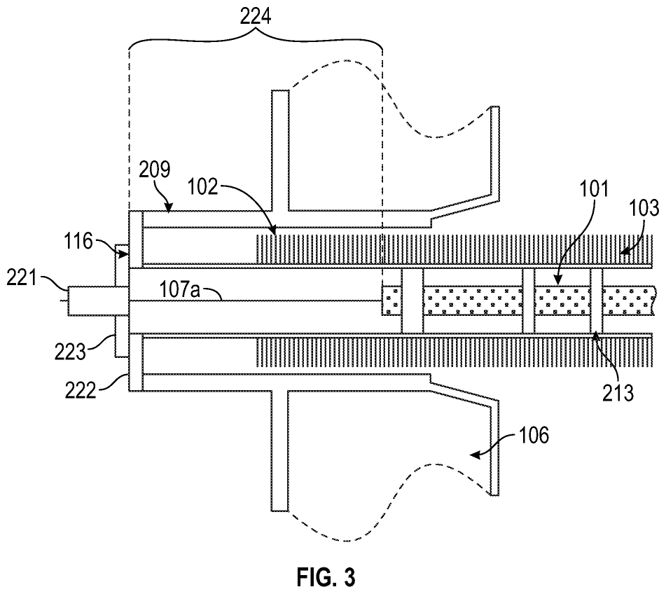

FIG. 3 shows a cross-sectional view of a tube 102 within an electric air heater module in accordance with one or more embodiments. More specifically, FIG. 3 shows a detailed cross-section of a tube 102 at the first end 116 of the outer casing 104. A heating element 101 may extend axially through the tube 102. In one or more embodiments, the heating element 101 may be a single element. However, there are also many embodiments in which the heating element 101 may be a bundle of individual heating elements secured together in parallel, in series, or both, along with appropriate electrical connectivity for the particular embodiment.

At a first end 116, the tube 102 may be fixed with a seal flange 222, which may be welded to the tube 102 and the sleeve 209. A cable 107a may extend from the seal flange 222 to the heating element 101. The seal flange 222 may have a central opening which may be sufficient in size to insert and withdraw the heating element 101. An end cap 223 may be provided to maintain heating elements in position. In one or more embodiments, the end cap 223 may be external to the refractory insulation layer 106. An electrical pass-through connection 221 may be provided through the end cap 223 and into the tube 102. The portion of the tube 102 through which the cable 107a extends may be referred to as an unheated length 224.

In one or more embodiments, a plurality of ceramic element supports 213 may be spaced throughout the tube 102 such that the heating element 101 is supported within the tube 102. The ceramic element supports 213 may be equally spaced throughout the tube 102, though there may also be embodiments in which the ceramic element supports 213 are not equally spaced.

In one or more embodiments, a plurality of fins 103 may be arranged circumferentially around the exterior surface of the tube 102. The plurality of fins 103 may assist in dissipating heat away from the heating elements, thus improving heating of the air within the electric air heater module.

A sleeve 209 may be tightly fitted around the tube 102 in the unheated length 205. In one or more embodiments, the sleeve 209 may define an outer portion of the insulation layer 106, which may be positioned at the first end 116 of the outer casing 104. The sleeve 209 may extend from the outer casing 104 and through an insulation layer 106. In one or more embodiments, the insulation layer 106 may be a refractory type insulation such as castable, ceramic fiber, insulating board, or any other type of high temperature insulating material.

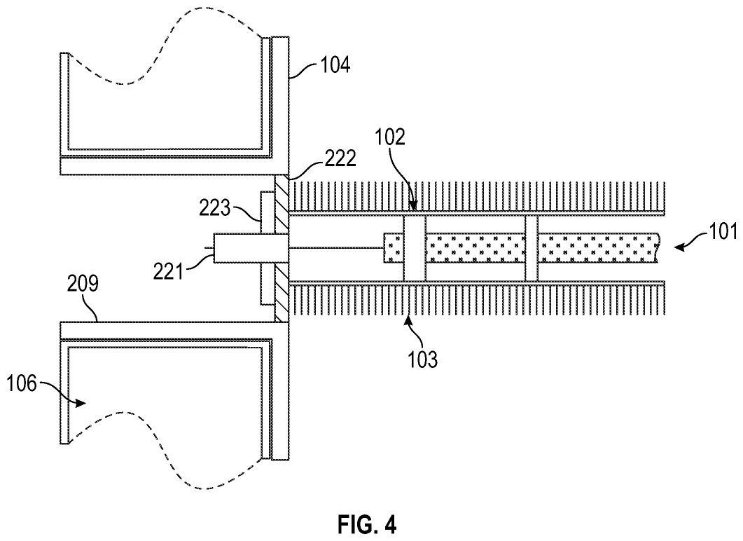

FIG. 4 shows a cross-sectional view of a tube 102 within an electric air heater module in accordance with one or more embodiments. More specifically, FIG. 4 shows a detailed cross-section of a tube 102 at the first end 116 of the outer casing 104. In one or more embodiments, as shown in FIG. 4, the refractory insulation layer 106 may be tightly fitted to the exterior of the outer casing 104. In one or more embodiments, the refractory insulation layer 106 may be castable or ceramic fiber, where ceramic fiber refers to an internal ceramic fiber insulation installed within a liner. Further, in some embodiments, the end cap 223 may be in-line with the outer casing 104, negating the need for the sleeve 209 and shortening the unheated length.

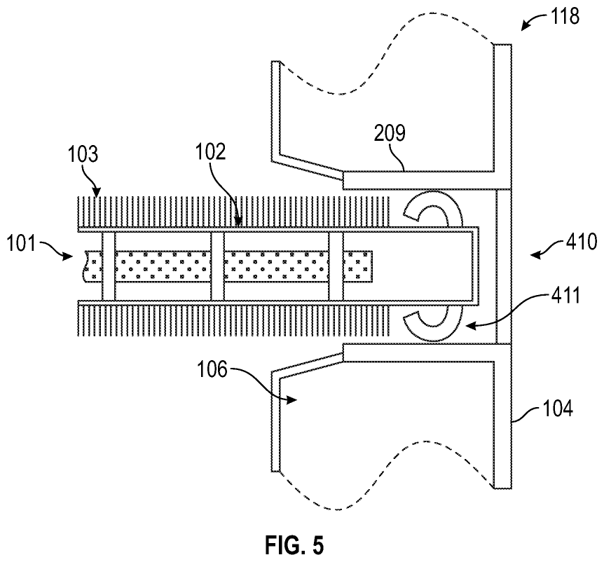

Turning now to FIG. 5, FIG. 5 shows a cross-sectional view of a tube 102 within an air heater module in accordance with one or more embodiments. More specifically, FIG. 5 shows a detailed cross-section of a tube 102 at the second end 118 of the outer casing 104. The second end 118 may be characterized by the tube 102 floating within the electric air heater module. In one or more embodiments, the sleeve 209 may define that space within the refractory insulation layer 106 in which the tube 102 may freely expand axially during heating. A terminal end of the heating element 101 may also be spaced from an end of the tube 102 to allow the heating element to freely expand within the length of the tube 102.

Radial expansion of the tube 102 may causes an increase in tube radius. In one or more embodiments, expansion may be on the order of millimeters. However, the order of expansion may differ based on the specific application and use of the electric air heater module.

In one or more embodiments, a vibration dampener 411 may be used to support the tube 102 at the second end 118. Further, the vibration dampener 411 may allow for thermal expansion of the tube 102, as well as reducing or preventing vibration of the tube 102 due to flow induced vibration. In one or more embodiments, a casing section or a cap 410 may be installed to seal the furnace environment from the external environment. The casing section or cap 410 may have assorted designs and geometry and may be insulated either externally or internally depending on situational needs.

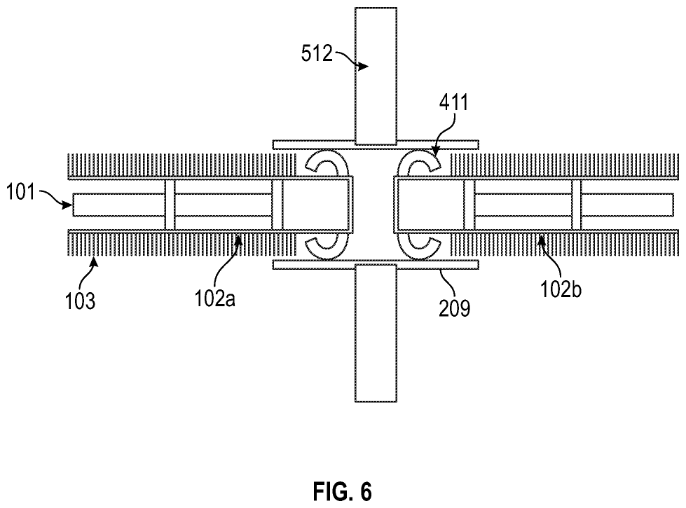

Turning now to FIG. 6, in one or more embodiments an intermediate support 512 may be installed at an intermediate point between the first end 116 and the second end 118 of the outer casing 104 (see FIG. 2). In such embodiments, the tube 102 may be split into a first section 102a and a second section 102b, where the intermediate support 512 is installed in a space between the two sections 102a, 102b. This may allow for tube expansion at an intermediate point, rather than at the second end 118 of the outer casing 104.

A vibration dampener 411 may be installed at the end of the first section 102a and at the end of the second section 102b. Further, a sleeve 209 may be installed from the end of the first section 102a to the beginning of the second section 102b to provide support for each section. In one or more embodiments, the tube 102 may have an electrical connection 107 installed at both the first end 116 and the second end 118, such that the tube 102 is fixed at both the first end 116 and the second end 118. Embodiments such as that depicted in FIG. 6 may be utilized when a large electric air heater module volume is desired, or to reduce the unsupported length of the tube 102.

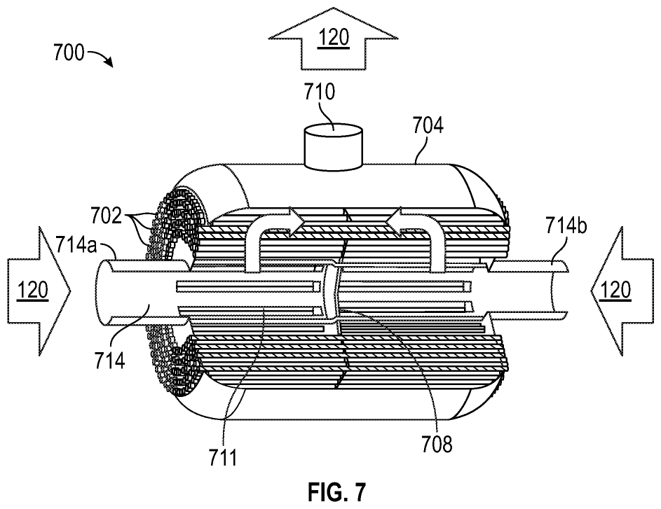

FIG. 7 shows a cutaway view of an electric air heater module in accordance with one or more embodiments. More specifically, FIG. 7 shows a radial electric air heater module 700. The radial electric air heater module 700 may have an inner cavity 714 extending axially through a cylindrical outer casing 704, which may be hollow. A plurality of tubes 702, similar to the tubes 102 described with respect to FIGS. 2-6, may be arranged radially around an inner cavity 714. In one or more embodiments, the plurality of tubes 702 may be arranged in circular rows or layers, such that each successive row has a larger radius than the previous row. Further, each successive row may have a different wattage level than the previous row. The inner cavity 714 may have a number of axial perforations 711 machined into its exterior wall to allow air to flow outwardly through the rows of tubes 702.

In one or more embodiments, a baffle 708 may be installed in the center of the outer casing 704 and the inner cavity 714, such that air flow from one side of the radial electric air heater module 700 to the other side is prevented. In such embodiments, air 120 may be directed into either end of the inner cavity 714, where each inner cavity 706 opening may act as an inlet 716, 718. The positioning of the baffle 708 may force air entering each inlet 716, 718 to flow through the plurality of rows 702 to reach an outlet 710. The air temperature in the upper half of the radial electric air heater module 700, i.e., the half closest to the outlet, may be higher than that in the lower half. However, there may be additional internal baffles installed in one or more embodiments to promote air flow around the entirety of the tubes 702, rather than just those in the upper half of the radial electric air heater module 700.

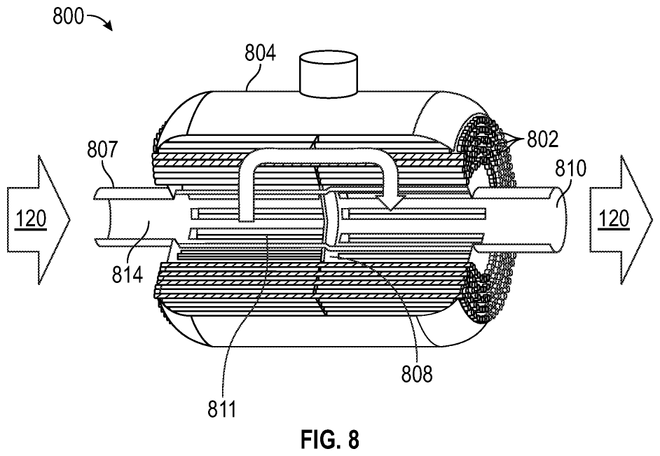

FIG. 8 shows a cutaway view of an electric air heater module in accordance with one or more embodiments. More specifically, FIG. 8 shows a radial electric air heater module 800 in accordance with one or more embodiments. Similar to the radial electric air heater module 700 depicted in FIG. 7, the radial electric air heater module 800 may include an inner cavity 814 extending axially through a hollow outer casing 804. The inner cavity 806 may have an inlet 807 disposed at one end, and an outlet 810 located at the opposite end. A plurality of tubes 802, similar to the tubes 102 described with respect to FIGS. 2-6, may be arranged in rows radially around the inner cavity 814. The inner cavity 814 may have a number of axial perforations 811 machined into its exterior wall to allow air to flow outwardly through the rows of tubes 802.

A baffle 808 may be installed in a center of the radial electric air heater module 800. In one or more embodiments, the baffle 808 may extend completely through the interior of the outer casing 804 and the inner cavity 814. In such embodiments, the baffle 808 may have a number of perforations in the surface area surrounding the inner cavity 806, such that air may flow through the perforations. In other embodiments, the baffle 808 may be disposed only in the inner cavity 814, such that air 120 may be free to flow through the interior of the outer casing 804 outside of the inner cavity 814.

In one or more embodiments, air 120 may be directed into the inlet 807 of the inner cavity 814, before being forced out of axial perforations 811 by the presence of the baffle 808 blocking air flow directly through the inner cavity 814. Air 120 may then be forced through the rows of tubes 802, such that air may flow through the entire interior of the outer casing 804. In one or more embodiments, there may be additional internal baffles (not pictured) installed within the interior of the outer casing 804 to ensure equitable air flow through the entire interior of the outer casing 804, avoiding a concentration of air flow through a given segment of the outer casing interior.

After air has been forced through the rows of tubes 802, it may re-enter the inner cavity 814 after the baffle 808 through several axial perforations 811. Air 120 may then flow out of the radial electric air heater module 800 via the outlet 810.

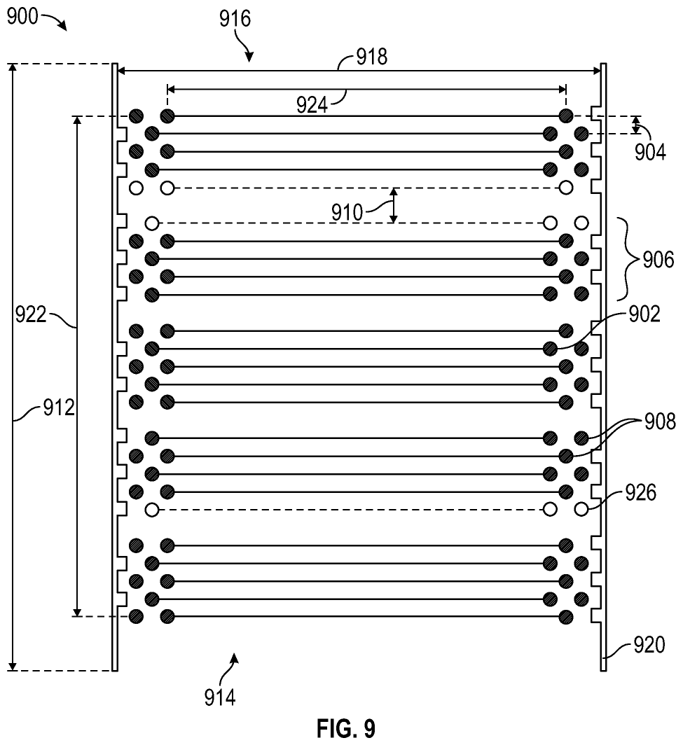

Turning now to FIG. 9, FIG. 9 shows a cross-sectional view of an electric air heater module 900 in accordance with one or more embodiments. Specifically, FIG. 9 shows a tube arrangement in accordance with one or more embodiments. The electric air heater module 900 may have a plurality of rows 908 of tubes 902 installed. For example, there may be some embodiments in which 25 rows 908 are installed, as depicted in FIG. 9, where each row 908 includes 16 tubes 902 in each row (not illustrated). However, alternate numbers of installed rows 908 and tubes 902 may be used, and it should be understood that the number of rows 908 and tubes 902 installed per row may change depending on situational needs.

In one or more embodiments, several rows 902 may be grouped together in a bundle 906. Within a bundle 906, the row spacing 904 may refer to the distance between each row 908. The bundle spacing 910 may refer to the distance between each bundle 906. Rows 902 and bundles 906 may be spaced and arranged to provide a tortuous flow path through the cavity, while additionally providing for sufficient spacing for expansion of the tubes 902 and fins and maintaining a relatively low pressure drop.

The electric air heater module 900 may have a height 912, which may be defined as the distance between the entry 914 and the exit 916. Further, the electric air heater module 900 may have a width 918, which may be defined as the distance between refractory insulation layers 920. The effective row height 922 may refer to the distance between the first and the last row 908 arranged within the electric air heater module 900. Similarly, the effective tube length 924 may refer to the length of each tube 902.

The number of tubes per row may vary within a bundle, such as a greater or fewer number of tubes in a first row as compared to a second row. For example, a row proximate an inlet of the heater may have a small number of central rows, accounting for eddies and development of flow within the heater from the inlet to a region of fully developed flow that may have a greater number of tubes per row. Further, the number of tubes, the number of tubes per row, may vary between a first bundle and a second bundle within the electric air heater module, similarly accounting for development of flow and changing flow dynamics and fluid properties as the gas passing through the heater is being heated.

The row spacing within a bundle may be uniform or non-uniform, and may vary, such as closer proximate an inlet of a heater and more spaced apart proximate an outlet of the heater, or vice versa. Similarly, the row spacing in the multiple bundles may be similar or different. As noted above, the bundle configurations may be varied from heater inlet to heater outlet to account not only for flow development, but to also account for changes in flow dynamics and fluid properties through the heater.

For embodiments having fins on the tubes, the fin height, fin thickness, number of fins per unit length, and other fin variables may vary between the tubes within a row, between rows of a bundle, or between bundles. For example, a first row or first bundle within a heating module may have a different fin configuration than a second row or second bundle within a heating module, respectively.

For heaters having two or more modules disposed in series, the modules may be of a similar design or of different design, accounting for fluid flow and properties, as noted above. Each module may be designed with an appropriate configuration with respect to one or more of module height, module width, row height, tube spacing, tube height, tube diameter, tube length, number of tubes per row, number of tubes per module, number of fins per unit length of tubes, fin height, fin thickness, materials of construction, etc., so as to provide the desired heat exchange.

In one or more embodiments, there may be several spare rows 926 installed. In one or more embodiments, spare rows 926 may also be referred to as empty rows. A spare row 926 may refer to a row 908 of tubes 902 which do not have installed heating elements, or in which the heating elements are not powered. For example, in some embodiments, there may be three spare rows 926 installed, where the spare rows 926 are interspersed amongst the bundles 906. Spare rows 926 may be utilized in case of failure of one or more heating elements within a row 908. For example, if a row 908 has one or more tubes 902 with failed heating elements, new heating elements can be inserted into the tubes 902 of one of the spare rows 926, or the un-powered heating elements may be powered. The spare row 926 can then act in the same manner as any other row 908. Further, the failed heating elements may be removed, creating a new spare row 926. In such a manner, heating elements may be repaired, including installation and removal, while the electric air heater module 900 is still in operation at full capacity. In embodiments where the heating element is to be removed, the weld on the seal flange may need to be cut and rewelding according to techniques known in the art.

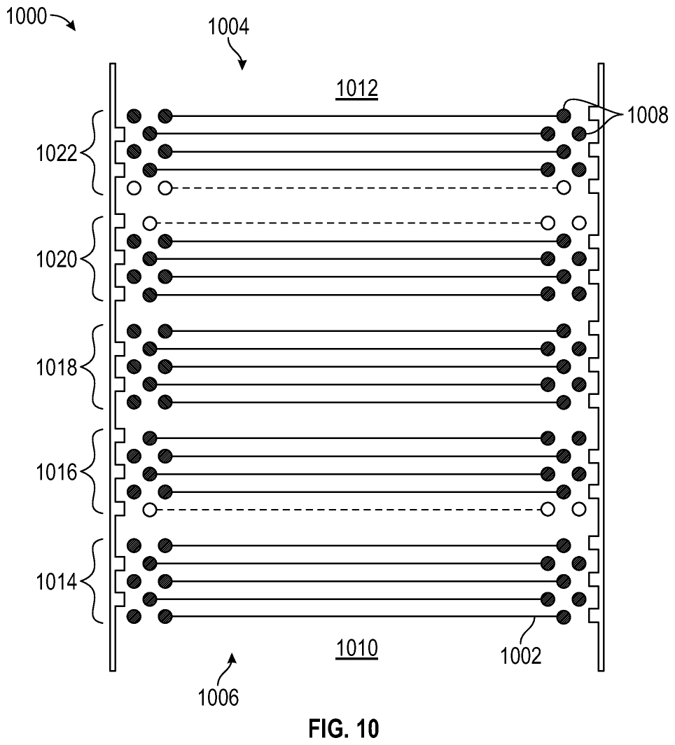

Turning now to FIG. 10, FIG. 10 shows a cross-sectional view of an electric air heater module 1000 in accordance with one or more embodiments. More specifically, FIG. 10 shows an exemplary example of an electric air heater module 1000 in accordance with one or more embodiments. The electric air heater module 1000 may have an entry 1006 and an exit 1004, between which a plurality of rows 1008 of tubes 1002 are arranged. Each tube 1002 may contain a heating element (not pictured). At the entry 1006, an entry temperature 1010 may be measured. At the exit 1004, an exit temperature 1012 may be measured. The rows 1008 may be arranged into five bundles 1014, 1016, 1018, 1020, 1022.

The first bundle 1014 may have a tube metal temperature (TMT), which refers to the temperature of the tube 1002. The first bundle 1014 may also have an inside temperature (Inside T), which may refer to the temperature of the heating element (such as 101 in FIG. 2A) within the tube 1002. Further, the first bundle 1014 may have a power. In one or more embodiments, each bundle of tubes 1002 may have a different power. However, there may be other embodiments in which some bundles of tubes 1002 have the same power.

Similarly, each of the second through the fifth bundles 1016, 1018, 1020, 1022 may have a TMT values, an inside T value, and a power value. In one or more embodiments, the respective TMT values, inside T values, and power values for each of the bundles 1014, 1016, 1018, 1020, 1022 may be different. However, there may be some embodiments in which one or more of the values are the same or substantially similar. In one or more embodiments, the electric air heater module 1000 may have a defined air flow rate in order to ensure maximum heating, as well as a total duty.

Table 1 displays an exemplary example of the electric air heater module 1000, with approximate ranges for each parameter related to the various components within the electric air heater module 1000. Though Table 1 describes one exemplary example, there may be many exemplary examples which may exist, each with varying parameter ranges, without departing from the scope of this disclosure.

TABLE 1

| Electric Air Heater | Exemplary Example | |
|---|---|---|
| Module Parameters | Approximate Ranges | |
| Tube Size | 5″ Nominal Pipe Size (NPS) | |
| Tube Rating | Sch. 40-80 | |
| Fin Frequency | 197 fins per meter | |
| Fin Height | 25 | mm |
| Fin Thickness | 1.3 | mm |
| Sleeve Thickness | 4-10 | mm |
| Row Spacing | 220 | mm |
| Bundle Spacing | 460 | mm |
| Module Height | 7200 | mm |
| Module Width | 4400 | mm |
| Effective Row Height | 6000 | mm |
| Effective Tube Length | 3000 | m |
| Entry Temperature | 400° | C. |
| Exit Temperature | 700° | C. |
| Tube Metal Temperature (TMT) | 630-830° | C. |
| Inside Temperature (Inside T) | 660-850° | C. |
| Bundle Power | 6 | MW |
| Module Power | 30 | MW |
| Expected Tube Axial Expansion | 20-30 | mm |

In one particular example, the electric air heater module 1200 may have an air flow rate of 313,800 kg/h and a total duty of 25.8 MMkcal/h. In the same example, the entry temperature 1210 may be 394° C. and the exit temperature 1212 may be 714° C. The first bundle 1214 may have a TMT of 635° C., an Inside T of 660° C., and a power of 80 kW per heating element. The second bundle 1216 may have a TMT of 700° C., an Inside T of 725° C., and a power of 80 kW per heating element. The third bundle 1218 may have a TMT of 765° C., an Inside T of 790° C., and a power of 80 kW per heating element. The fourth bundle 1220 may have a TMT of 800° C., an Inside T of 840° C., and a power of 80 kW per heating element. The fifth bundle 1222 may have a TMT of 830° C., and Inside T of 850° C., and a power of 60 kW per heating element.

In one or more embodiments, the Inside T value may be higher than the TMT value. Further, the power value may vary between bundles. Though one example is presented above, it should be understood that there are many other examples which may also be implemented in an electric air heater module such as that shown in FIG. 10 without departing from the scope of this disclosure.

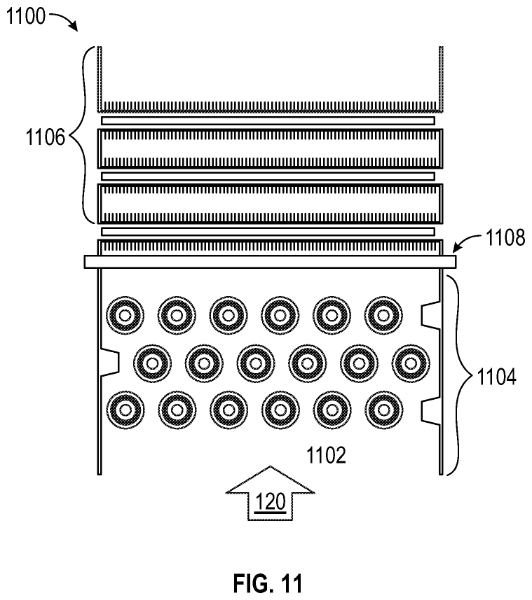

Turning now to FIG. 11, FIG. 11 shows a cross-sectional view of an electric air heater system 1100 in accordance with one or more embodiments. In one or more embodiments, the electric air heater system 1100 may include a first portion 1104 of the electric air heater 1100 and a second portion 1106 of the electric air heater 1100 in series. The electric air heater system 1100 may also include a connection point 1108 disposed between the first and second portion of the electric air heater 1104, 1106. In one or more embodiments, a portion may refer to a section of the electric air heater system 1100 in which one or more bundles of tubes 1102 are configured in a single direction. The connection point 1108 may refer to a change in the configuration of the bundles of tubes, such that the bundles of tubes disposed within the first portion 1104 extend axially at an angle from the bundles of tubes disposed within the second portion 1106.

In one or more embodiments, the first and second electric air heater portions 1104, 1106 may be stacked at an angle, such that one electric air heater portion faces in one direction and the second electric air heater portion faces in another direction. In one or more embodiments, the first and second electric air heater portions may be offset by 90 degrees. In these embodiments, the tubes of the first electric air heater portion 1104 may be oriented at a 90-degree angle to the tubes of the second electric air heater portion 1106. However, it should be understood that this angle is simply an example, and the first and second electric air heater portions 1104, 1106 may be arranged with an offset of any angle between 0 degrees to 90 degrees without departing from the scope of this disclosure. Further, the tubes of the first electric air heater portion 1103 may be oriented at a 180° angle to the tubes of the second electric air heater portion 1106. The power connection of the portion 1104 and 1106 may then be at the opposite ends. Arranging successive electric air heater portions at an angle from the previous portion may provide more open space for the electrical power connection and more room for heater maintenance activities.

In one or more embodiments, the bundles of tubes 1102, particularly how many tubes are included in a bundle, may be determined based on desired total power. For example, each bundle of tubes 1102 may be a 5 MW unit, such that the power supply connected to the bundle of tubes 1102 is associated with a 5 MW transformer. This, however, is simply an example, and there may be many different transformers with varying power outputs which may be associated with each bundle of tubes 1102. By powering each bundle of tubes 1102 independently, the single electric air heater system 1100 may provide more than 170 MW of energy in some embodiments.

FIG. 11 shows one example of an arrangement of the tubes 1102 within the first electric air heater portion 1104. In this embodiment, the tubes 1102 are arranged in a parquet style (i.e., an arrangement where tubes are arranged at 90° with respect to previous rows or bundles). However, there are other embodiments in which the tubes 1102 may be arranged in a soldier course style. In one or more embodiments, the tubes 1102 may be positioned in a staggered arrangement. However, there are also other embodiments in which the tubes 1102 are positioned in an inline arrangement. In one or more embodiments, fin tube cleaning doors or access doors may be installed between the first and second electric air heater portions 1104, 1106.

In one or more embodiments, the tubes 1102 located in the first electric air heater module 1104 may be made from the same material as the tubes 1102 located in the second electric air heater module 1106. However, in other embodiments the tube material may vary between the first and second electric air heater modules 1104, 1106.

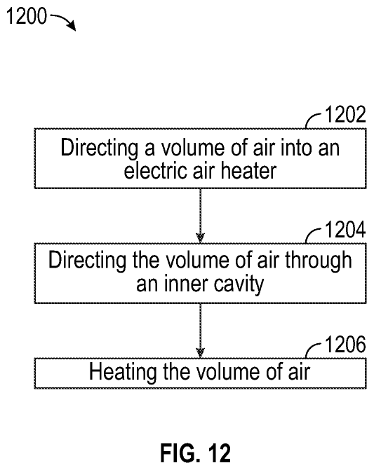

Turning now to FIG. 12, FIG. 12 depicts a flowchart 1200 of a method for heating a volume of air within an electric air heater module. Initially, in step 1202, a volume of air may be directed into an electric air heater, such as electric air heater module 100. Next, in step 1204, a volume of air may be directed through an inner cavity of the electric air heater module 100. Within the electric air heater module 100, a plurality of rows of tubes may be arranged in accordance with one or more of the embodiments described herein. The volume of air may be forced through the rows of tubes, such that the air may be heated, as described in step 1206.

In one or more embodiments, the electric air heater module may be a radial electric air heater module, such as those depicted in FIGS. 7 and 8. In these embodiments, the method may further include directing the volume of air through the inner cavity to a baffle disposed in a center of the inner cavity and forcing the volume of air outwards from the center of the interior cavity and through the one or more layers of tubes.

In one or more embodiments, the electric air heater module may include one or more bundles of tubes, such as the bundle 906 depicted in FIG. 9. The bundle may include one or more tubes, where the number of tubes utilized is selected based on desired total power. Each bundle may accordingly have a power, and the electric air heater module may have a total power composed of a combination of the power of each bundle. As a result, the single electric air heater module may provide over 170 MW of energy in some embodiments.

Embodiments of the present disclosure may provide at least one of the following advantages. In currently available commercial heaters, maximum temperature must be limited to avoid overheating of heating elements. Further, as gas flows over successive elements, the gas heats to a temperature where it is less able to dissipate heat. As such, the heater elements at the hottest part of the heater assembly must operate at much lower watt densities than is desired. Further, in many currently available air heaters, the heating elements are exposed within the heater, such that the gas flows directly over the elements.

In comparison, embodiments of the present disclosure allow for much higher temperatures and watt densities without causing overheating or failure of heating elements. Further, embodiments of the present disclosure allow for easy repair and replacement of heating elements during operation of the electric air heater. Since the heating elements are fully enclosed within tubes, which may be considered controlled environments, a stable oxide layer may be maintained on the heating element surface, prolonging the life of the element. In addition, positioning the heating elements within controlled environments allows for the heating of corrosive, flammable, or otherwise difficult product gases.

Embodiments of the present disclosure may also allow for a large volume flow of gas (for example, a mass flow rate of greater than 100,000 kg/h) to be heated at a low pressure from a nominal preheat temperature of 343° C. to over 760° C. However, embodiments of the present disclosure are not limited to a maximum inlet or minimum inlet temperature of 343° C. Further, embodiments of the present disclosure may allow for large volume heating, while maintaining a pressure drop of less than 13.8 kPa. In some embodiments, this pressure drop may also be limited to less than 7 kPa.

Embodiments of the present disclosure may also allow for avoidance of overheating of heating elements. The heat transfer induced from the heating elements to the tubes is primarily radiative and is controlled by the cooling of the tube by gas flowing through the inner cavity of the electric air heater module. Heat transfer may be further improved by adding fins to the outer circumference of the tube, thereby increasing the effective surface area for convective heat transfer, which improves dissipation of heat away from the tubes and cooling of the tubes.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. An electric air heater system, comprising:
a first electric air heater module;
wherein the first electric air heater module comprises:
an outer casing, having an inner surface, a first end, and a second end, a refractory insulation layer in tight communication with the outer casing;
an inner cavity within the refractory insulation layer;
a plurality of tubes extending through the inner cavity from the first end to the second end, the plurality of tubes each having an exterior surface,
wherein each tube is fixed relative to the outer casing at the first end, and each tube has an electrical connection disposed at the first end;
wherein the plurality of tubes is arranged into one or more bundles of tubes, where each bundle comprises two or more tubes;
wherein each tube has a plurality of fins extending radially from the exterior surface, and
wherein each tube has a heating element axially through a hollow interior of the tube; and
a sleeve supporting each of the plurality of tubes at the second end of the outer casing.

2. The electric air heater system of claim 1, further comprising a second electric air heater portion rotated at angle to the first electric air heater portion.

3. The electric air heater system of claim 2, wherein each of the one or more bundles is connected to a separately controlled power bank.

4. The electric air heater system of claim 3, wherein the heating element of the first electric air heater portion is a different heating element type than the heating element of the second electric air heater portion.

5. The electric air heater system of claim 1, wherein the plurality of tubes are arranged in two or more rows and wherein one or more rows of tubes are unpowered.

6. The electrical air heater system of claim 1, wherein the first electrical air heater module has a rectangular cross section or a cylindrical cross section.

7. The electrical air heater system of claim 6, wherein the first electrical air heater module having the cylindrical cross section comprises:
a cylindrical outer casing;
a rectangular inner casing configured to receive an air flow; and
wherein the refractory insulation layer covers the rectangular inner casing.

8. An electric air heater, comprising:
an outer casing, having an inner surface defining an inner cavity, a first end, and a second end,
a refractory insulation layer in tight communication with the outer casing;
a plurality of tubes extending axially through the inner cavity from the first end to the second end, the plurality of tubes each having an exterior surface,
wherein the plurality of tubes is arranged radially around an axial center of the inner cavity,
wherein each tube is fixed relative to the outer casing at the first end, and each tube has an electrical connection disposed at the first end,
wherein each tube has a plurality of fins arranged extending radially from the exterior surface, and
wherein each tube has an electrical heating element disposed axially through a hollow interior of the tube; and
a sleeve supporting each of the plurality of tubes at the second end of the outer casing.

9. The electric air heater of claim 6 wherein the electrical heating element disposed axially through each tube comprises a plurality of heating elements arranged in parallel or in series and an electrical wire.

10. The electric air heater of claim 8, wherein each heating element is supported by at least one ceramic element support.

11. The electric air heater of claim 8, wherein each heating element is selected from a group consisting of an iron-chromium-aluminium metallic wire, a nickel-chromium metallic wire, a silicon carbide rod, and a molybdenum disilicide heating element.

12. The electric air heater of claim 8, wherein a geometry of the plurality of fins is selected from a group consisting of a circular solid fin, a serrated fin, or a stud fin.

13. The electric air heater of claim 8, wherein the refractory insulation layer comprises a castable refractory material, ceramic fiber, or an insulating board.

14. The electric air heater of claim 8, wherein the electric air heater comprises an inner casing disposed inside the outer casing, and wherein the refractory insulation layer is in tight communication with an exterior surface of the outer casing or inner casing.

15. The electric air heater of claim 8, further comprising a vibration dampener disposed around each of the plurality of tubes at the second end of the outer casing.

16. The electric air heater of claim 8, wherein the plurality of tubes are connected to the outer casing at the first end.

17. The electric air heater of claim 16, further comprising a thermal expansion area at the second end.

18. The electric air heater of claim 8, further comprising a support installed in a center of the inner cavity.

19. The electric air heater of claim 18, wherein one or more of the plurality of tubes comprises two tube sections arranged about the support and wherein a thermal expansion area of each of the two tube sections is located at the support.

20. The electric air heater of claim 8, wherein the electric air heater has a first portion and a second portion, each portion having one or more tubes and wherein the first portion and the second portion are rotated with respect to each other.

21. A method of heating air, comprising:
directing a volume of air into an electric air heater,
wherein the electric air heater comprises:
an outer casing;
an inner cavity disposed through the outer casing;
a refractory insulation tightly fitted to the outer casing; and
a plurality of tubes extending through the inner cavity,
wherein the plurality of tubes is arranged into one or more layers;
directing the volume of air through the inner cavity; and
heating the volume of air.

22. The method of claim 21, further comprising:
directing the volume of air through the inner cavity to a baffle disposed in a center of the inner cavity; and
forcing the volume of air outwards from the center of the inner cavity and through the one or more layers of tubes.
